(19) United States
(12) Patent Application Publication
(10) Pub. No.: US 2014/0304064 A1
(43) Pub. Date: Oct. 9, 2014

(54) Smart Billing System

(71) Applicant: Snap MyLife, Inc., Princeton, NJ (US)

(72) Inventor: Leon Podolsky, Princeton, NJ (US)

(21) Appl. No.: 13/859,393

(22) Filed: Apr. 9, 2013

(51) Int. Cl. G06Q 30/02

(52) U.S. Cl. CPC G06Q 30/0244
USPC 705/14.43

(57) ABSTRACT

A method for optimizing ad-based conversions is provided. The method may comprise the steps of receiving user input from a user through one or more ad-based entry points, where each entry point providing one or more reference codes in response to the user input; initiating a subscription sequence based on the reference codes; randomizing a plurality of concurrently available advertising campaigns selected based on the reference codes; selecting at least one landing page from the randomized advertising campaigns to be presented to the user based on the reference codes; and determining a conversion rate based at least partially on one or more of the reference codes, the engaged entry point, the selected advertising campaign and landing page.

### TECHNICAL FIELD

The present disclosure generally relates to advertising campaigns, and more particularly, to systems and methods for optimizing ad-based conversions.

### BACKGROUND

The strive for more efficient and more effective advertisements is an ongoing one, and one which is commonly shared by essentially all participants of almost any industry. Before any improvements can be made to an advertising campaign, however, the advertiser must invest significant amounts of time and effort in assessing the performance, effectiveness and cost of running each of a variety of different advertising campaigns. Moreover, due to several uncontrollable factors or variables, the task of assessing the effectiveness of different advertising campaigns in and of itself can be a taxing one.

Many advertising campaigns employ, for instance, advertisement banners which are positioned within a visible area of a web site, application, computer program, or the like. A typical banner may display graphical advertisements for a particular subscription, service or product, which in some cases, may be modified to relate to the interests of the user. Often embedded within the banner are web site addresses or other pointers which, when clicked or selected upon by the user, redirects the user to a landing page associated with the advertised content. At the landing page then, the user is prompted to subscribe or sign up for free or trial services, or otherwise purchase a service or product.

If the advertisement banner is successful in achieving a subscription or a purchase by the engaging user, this is referred to as a conversion, or in this particular case, a click-through conversion. Such click-through conversions may be assessed in the form of conversion rates, or generally, the ratio of successful conversions to unfruitful click-throughs. The assessment of click-through conversions or conversion rates is of significant importance to advertisers as it provides one of the few relatively reliable measures of gauging the effectiveness of their advertising campaigns. While click-through conversions are still widely used for the purposes of assessing advertising campaigns, there is some room for improvement.

In many situations, the determination of the conversion rate of a single advertising campaign is not of much use unless it is compared with the conversion rates of other comparable campaigns. In many situations, advertisers may prefer to gauge the conversion rates of a particular advertising campaign against other variant campaigns to better understand the factors that make for more effective advertisements. One method of accomplishing this, A/B testing, allows marketers to generate a number of different website and/or landing page variations of a particular campaign. Based on the relative effectiveness assessed between the variations during A/B testing, advertisers and marketers can determine the more effective campaign and employ that campaign for all targeted conversions related to that campaign. In doing so, however, it is often difficult to ensure that there is no bias to any one or more of the advertising campaigns which may compromise the integrity of the A/B test results and related analyses.

In addition to increasing campaign effectiveness, another area of focus relates to successfully transacting a purchase and collecting revenue through a particular campaign. While within a campaign, users may express a desire to or agree to purchase the associated service or product, but not always participate in the final steps needed to complete the relevant transactions. Although these users may be billed using other means outside of the campaign, such inconsistencies further add to the complications of providing more reliable analytics when combined with the results of A/B testing analyses. There are also difficulties in making modifications to the campaigns, the A/B testing routines and/or the billing schemes without adversely affecting the consistency of the analytics.

Accordingly, there is a need to provide improved systems or methods for optimizing ad-based conversions. More specifically, there is a need to assess the effectiveness or conversion rates of various advertising campaigns within an A/B testing routine in an unbiased and a more reliable manner. There is also a need to streamline transactional analytics with the A/B testing results to provide for a more consistent and an all-inclusive system for assessing advertising campaign effectiveness. There is also a need for a more modifiable system that can readily adapt to different advertising campaigns, different market niches, and the like.

### SUMMARY OF THE DISCLOSURE

In one aspect of the present disclosure, a method for optimizing ad-based conversions is provided. The method may comprise the steps of receiving user input from a user through one or more ad-based entry points, each entry point providing one or more reference codes in response to the user input; initiating a subscription sequence based on the reference codes; randomizing a plurality of concurrently available advertising campaigns selected based on the reference codes; selecting at least one landing page from the randomized advertising campaigns to be presented to the user based on the reference codes; and determining a conversion rate based at least partially on one or more of the reference codes, the engaged entry point, the selected advertising campaign and landing page.

In another aspect of the disclosure, a method for optimizing ad-based conversions is provided. The method may comprise the steps of initiating a subscription sequence based on user input received from a user through one or more ad-based entry points, each entry point providing one or more reference codes in response to the user input; extracting information specific to the user from the reference codes; randomizing a plurality of concurrently available advertising campaigns selected based on the reference codes; selecting at least one landing page from the randomized advertising campaigns to be presented to the user based on the reference codes; and determining a conversion rate based at least partially on one or more of the reference codes, the engaged entry point, the selected advertising campaign and landing page.

In yet another aspect of the disclosure, a system for optimizing ad-based conversions is provided. The system may comprise a storage device configured to retrievably store information pertaining to one or more of ad-based entry points, reference codes, advertising campaigns, landing pages, and any predefined associations therebetween; and a primary network device in communication with the storage device. The primary network device may include at least one processor configured to receive user input from a user through one or more entry points where each entry point provides one or more reference codes in response to the user input, initiate a subscription sequence based on the reference codes, randomize a plurality of concurrently available advertising campaigns selected based on the reference codes, select at least one landing page from the randomized advertising campaigns to be presented to the user based on the reference codes, and determine a conversion rate based at least partially on one or more of the reference codes, the engaged entry point, the selected advertising campaign and landing page.

### BRIEF DESCRIPTION OF THE DRAWINGS

FIG. 1 is a schematic view of an exemplary system for optimizing ad-based conversions as constructed in accordance with the teachings of the present disclosure;

FIG. 2 is a diagrammatic view of a plurality of entry points to advertising campaigns that are engageable by a user;

FIG. 3 is a diagrammatic view of an exemplary method for optimizing ad-based conversions;

FIG. 4 is a diagrammatic view of one application of an optimizing ad-based conversion using an advertisement banner entry point;

FIG. 5 is a tabular view of reference codes that may be received, extracted and generated by an extraction process;

FIG. 6 is a diagrammatic view of one billing process as performed by the present disclosure;

FIG. 7 is a diagrammatic view of a device check process as performed by the present disclosure; and

FIG. 8 is a diagrammatic view of an in-app purchase routine as performed by the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

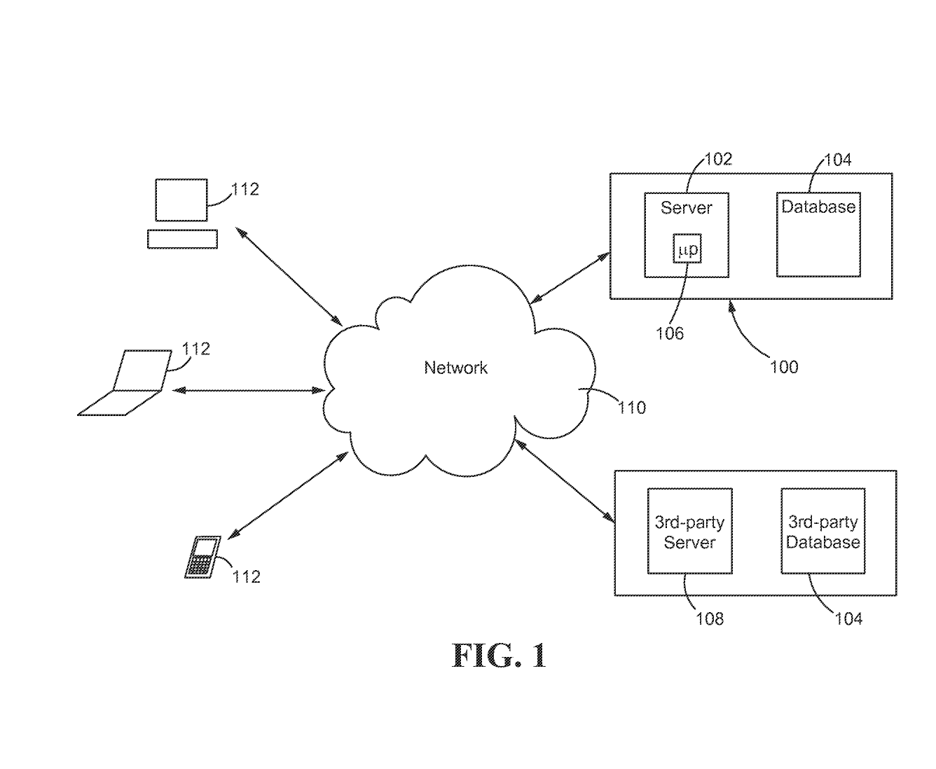

Referring now to FIG. 1, an exemplary system 100 for optimizing ad-based conversions is provided. As shown, the conversion optimization system 100 may generally include at least one primary network device 102 and a storage device 104 that is directly or indirectly accessible to the primary network device 102. The primary network device 102 may include one or more servers or other suitable computational devices with at least one processor 106 that is configured to manage at least partial operation of the conversion optimization system 100. The processor 106 may be implemented using any one or more of a controller, a microcontroller, a processor, a microprocessor, or any other suitable device that is programmable to operate according to one or more predefined algorithms, sequences, instructions, program code, or the like.

The storage device 104 of FIG. 1 may include at least a database or any other form of memory suitable for retrievably storing, among other things, data or information pertaining to one or more advertising campaigns, and the like. The primary network device 102 may be configured to electronically access various data and information from the storage device 104 either directly or indirectly, for instance, over a wired or a wireless connection, or over any other suitable connection therebetween. In other modifications, the storage device 104 may be at least partially shared with other secondary network devices 108, for example, servers belonging to third-party affiliates, and the like. In still further modifications, the primary network device 102 may communicate with storage devices 104 that are associated with secondary network devices 108, for example, servers belonging to third-party affiliates, and the like.

The primary network device 102 of the conversion optimization system 100 may further be configured to communicate over a network 110 with one or more connected computational and/or network client devices 112. The network 110 may include a local area network (LAN), a wide area network (WAN), a private network, a public network, a cellular network, a landline telephone network, or any other suitable network providing electronic communication between a client device 112 and the primary network device 102. The client devices 112 may include a mobile device, a cellular phone, a landline telephone, a laptop computer, a desktop computer, a server, or any other computational device capable of electronic communication with the primary network device 102 over the network 110.

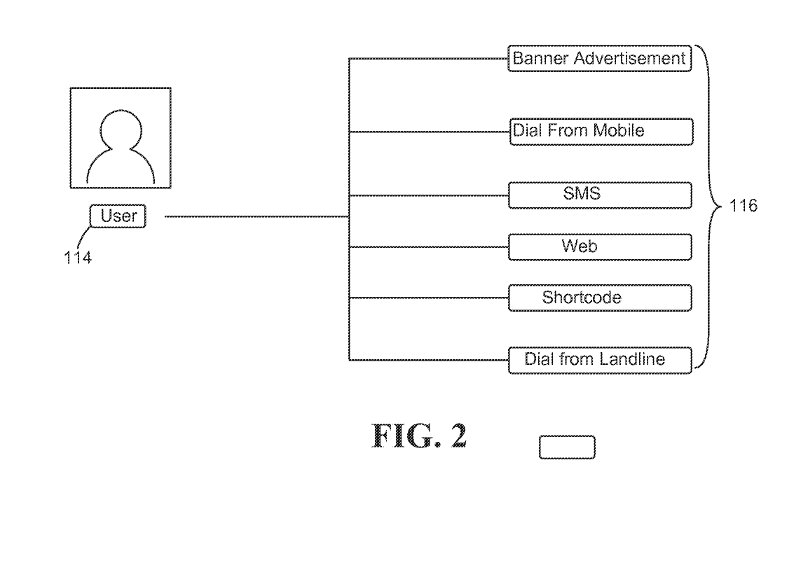

Still referring to the conversion optimization system 100 of FIG. 1, the processor 106 of the primary network device 102 may generally manage operation of one or more advertising campaigns that are communicated over the network 110 and directed to one or more users who are simultaneously connected to the network 110 using various client devices 112. More specifically, as shown in FIG. 2 for example, the primary network device 102 may present connected users 114 with one or more ad-based entry points 116 that are associated with one or more concurrently operating advertising campaigns. The ad-based entry points 116 may be engageable by a user 114 at the client device 112 and communicated in the form of, for example, advertisement banners, advertisement web pages, advertisement applications or programs, instant messages, text messages, shortcodes, phone calls, and the like.

Correspondingly, the storage device 104 may retrievably store information pertaining to different forms of ad-based entry points 116, advertising campaigns, landing pages, and the like, which may be readily retrieved by the primary network device 102 and used to present various advertising campaigns to one or more users 114 connected to the network 110. The storage device 104 may further store any predefined associations between any one or more of the entry points 116, advertising campaigns and landing pages, for example, in the form of reference codes, or the like, which the primary network device 102 may use to characterize the user 114, personalize advertising campaigns and landing pages for the user 114, and facilitate any subscription or billing sequences engaged by the user 114. The primary network device 102 may further employ reference codes, or the like, to gauge any successful conversions resulting from any subscription or billing sequences engaged by the user 114.

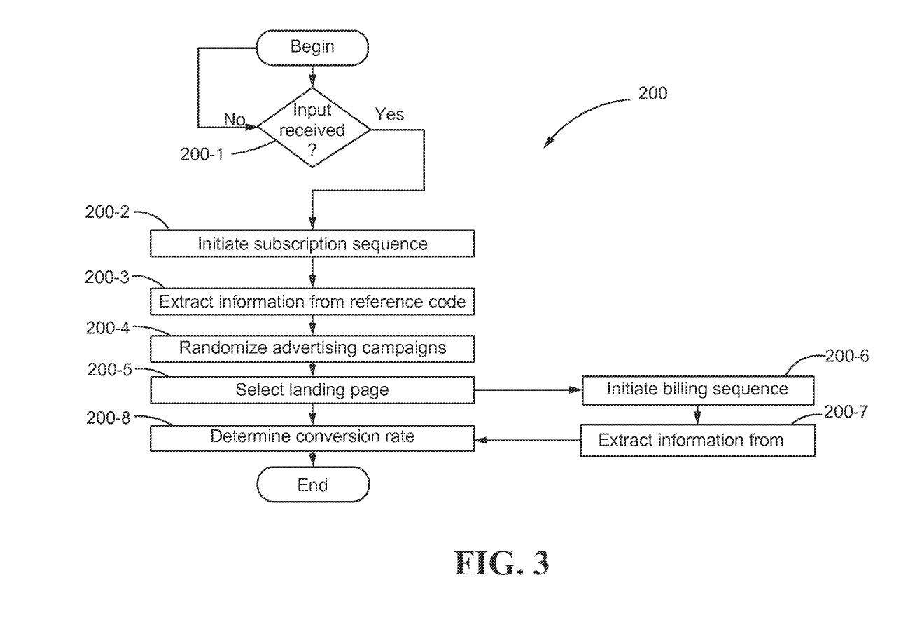

Turning now to FIG. 3, one exemplary algorithm or method 200 by which, for example, the processor 106 of the primary network device 102 may optimize ad-based conversions, is provided. In an initial step 200-1, the primary network device 102 may be configured to monitor for any response or interaction from a user 114 at any of the ad-based entry points 116 distributed throughout the network 110. For instance, in the case of an entry point 116 that is posed as an advertisement banner within an application or a web browser, the primary network device 102 may monitor user activity for any tapping, touching, pointing, clicking, or some other detectable mode of engaging the banner. If no user activity or engagement is detected, the primary network device 102 may continue monitoring the entry points 116 for such activities in cycles and/or within a predefined frequency. If user input is received, the primary network device 102 may be configured to proceed to step 200-2.

Furthermore, each of the entry points 116 may be configured to automatically provide or generate one or more reference codes in response to the user input. More specifically, when a user 114 engages an entry point 116, the entry point 116 may generate a reference code which codifies any combination of user-specific information, for example, pertaining to one or more of the type of entry point 116 engaged by the user 114, the relevant advertising campaign, the type or source of referral, the service or product of interest, and the like, into one or more strings of alphanumeric characters that are decodable by the primary network device 102. The reference code may also include or encode therein demographic or other related information, such as the user's identity, the user's location, the type of client device 112 used to engage the entry point 116, the user's cellular service provider, the user's internet service provider, or any other user-specific information that may be readily accessible through the user's engagement with the entry point 116.

The subscription sequence in step 200-2 of FIG. 3 may be initiated, for instance, to enable the engaging user 114 to subscribe to a service or a product that is associated with or relevant to the advertisement engaged in step 200-1. In a web-based implementation, for example, the primary network device 102 may direct the engaging user 114 to one or more landing pages within which the user 114 may subscribe to the service or product of interest. Moreover, components within the subscription sequence, for example, the landing pages within a web-based implementation, may be personalized or tailored to the engaging user 114 to better promote the subscription to the user 114, and/or to facilitate the subscription process for the particular user 114. Thus, in step 200-3, the primary network device 102 may be configured to extract user-specific information from one or more of the reference codes received during step 200-1 in order to modify the subscription sequence accordingly.

The primary network device 102 may be configured to automatically decode or extract user-specific information or other related attributes and identification information from the references codes based on predefined definitions and/or associations preprogrammed within a memory of the primary network device 102 and/or a storage device 104 that is accessible thereto. For instance, different sections of each string of alphanumeric characters within a reference code may correspond to different categories of attributes, and the specific characters within those sections of the string may correspond to the specific traits associated with the engaging user 114. Correspondingly, the primary network device 102 may decode different sections within the reference code to generally characterize the user 114 and to ascertain the most appropriate advertising campaign and/or landing page.

As shown in step 200-4 of FIG. 3, the primary network device 102 may further be configured to randomize a plurality of advertising campaigns prior to advancing the user 114 through the subscription sequence. More specifically, a plurality of available advertising campaigns may be concurrently active and stored within one or more associated databases 104. Among the various and potentially unrelated advertising campaigns, the primary network device 102 may be able to filter and select only those campaigns related to the user's area of interest based on the reference code received during step 200-1. The primary network device 102 may further randomize the advertising campaigns, or randomly select one of the remaining advertising campaigns to be applied during the subscription sequence. The randomizing step 200-4 may serve to reduce the presence of any bias or other inconsistencies within any comparative assessment of effectiveness, or conversion rate, between the different advertising campaigns.

In step 200-5 of FIG. 3, the primary network device 102 may be configured to select a landing page based on both the reference code received during step 200-1 as well as the randomly selected advertising campaign in step 200-4. The landing page may generally be configured to receive information submitted by the user 114, and to request confirmation for the user's subscription to the associated service and/or product. For example, the landing page may request the user's agreement or confirmation to the subscription, the user's identification or contact information, and the like. The landing page may be presented in the form of web pages, text messages, instant messages, applications, programs, shortcodes, automated telephone calls, or any other mechanism by which the user 114 is able to electronically confirm subscription. In addition, the type of landing page presented may be personalized to the engaging user 114 at least partially based on user-specific information extracted from the reference code obtained in step 200-1.

Additionally or optionally, the primary network device 102 may be configured to initiate a billing sequence as shown in step 200-6 of FIG. 3, and select a corresponding billing page in step 200-7. For example, upon receiving the subscription confirmation from the user 114 in step 200-5, if payment for a service and/or product is required, the primary network device 102 may select a billing page, or the like, to which the user 114 may be directed. Similar to the landing page of step 200-5, the billing page may be adapted to receive any billing information from the user 114, and to request confirmation of payment. For example, the billing page may request the user's agreement or confirmation to the payment, the user's identification or contact information, the user's payment and billing information, and the like. The billing page may also be presented in the form of web pages, text messages, instant messages, applications, programs, shortcodes, automated telephone calls, or any other mechanism by which the user 114 is able to electronically confirm payment. Furthermore, the type of billing page presented may also be personalized to the engaging user 114 at least partially based on user-specific information extracted from the reference code obtained in step 200-1.

The primary network device 102 may also be configured to determine a conversion rate of any successful subscriptions and/or billings in step 200-8 of FIG. 3. In general, the conversion rate may correspond to the measured rate of which an advertising campaign results in a successful subscription or billing of the engaging user 114. The primary network device 102 may calculate the rate of any successful conversion based on one or more of the entry point 116 engaged by the user 114, the advertising campaign and/or the landing page selected by the primary network device 102, returned subscription or billing confirmations, and the like. Alternatively, the conversion rate may be adequately calculated at least partially based on the reference code received during step 200-1 as all of the information pertaining to the entry points, advertising campaigns, landing pages, and the like, may be embodied therein.

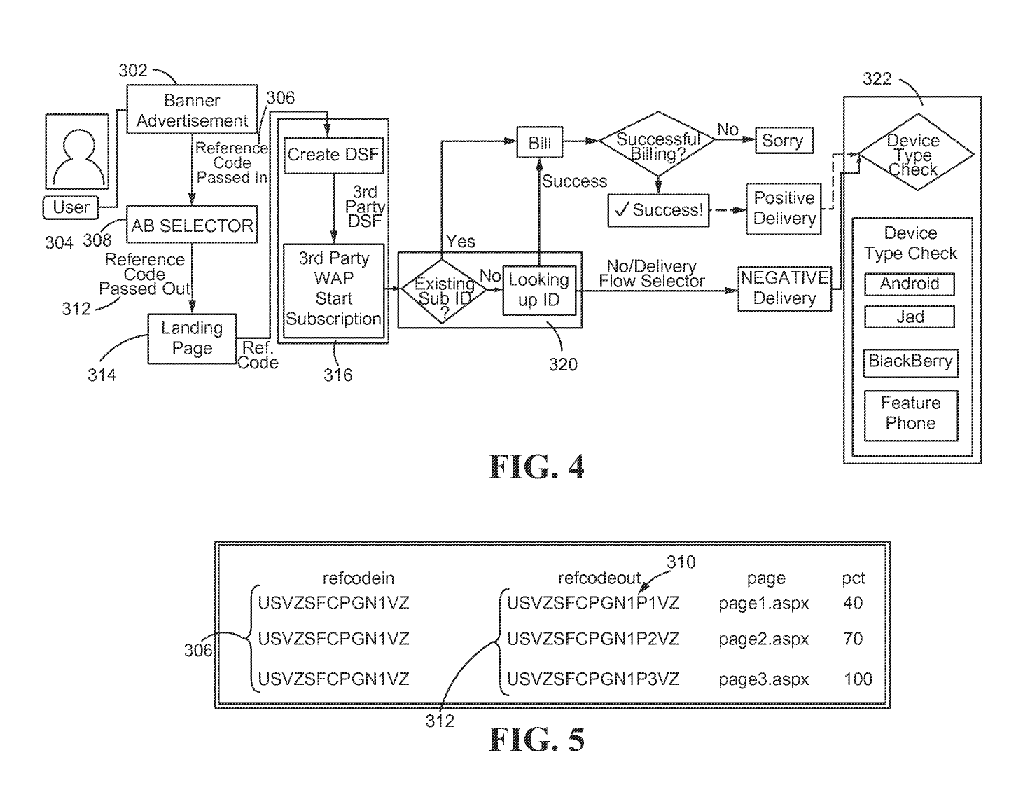

Turning now to FIG. 4, one exemplary application 300 of the method 200 of FIG. 3 is diagrammatically provided in more detail. As shown, the entry point 116 depicted in the application 300 employs an advertisement banner 302 that may be presented to a user 304 and situated, for instance, within an application of a mobile phone or device, within a program for a desktop or laptop computer device, within a web page of a web browser, or the like. If and once the user 304 interacts or otherwise engages with the banner 302, the banner 302 may automatically generate a reference code 306 to be forwarded to, for example, an extraction process 308 of the primary network device 102, or the like. As shown in FIG. 5 for example, the extraction process 308 of the primary network device 102 may be preprogrammed to extract information from within the reference code 306 and to select a plurality of different advertising campaigns 310 that would be most relevant to the engaging user 304 based on the reference code 306. Moreover, the extraction process may employ an A/B testing scheme to randomize and further optimize the presentation of the advertising campaigns 310 such that any conversions resulting therefrom can be assessed, as well as compared with the conversion rates of other advertising campaigns 310, in a more consistent and an unbiased manner.

In addition, the extraction process 308 may generate an outgoing reference code 312 designating each of the randomized advertising campaigns 310 available. Specifically, each outgoing reference code 312 may contain, among other things, extractable information sufficient to indicate to the primary network device 102 the A/B randomized advertising campaign 310 to be employed, as well as any one or more landing pages 314 associated therewith. Furthermore, one of the reference codes 312, and thus, one of the advertising campaigns 310 may be selected to be applied and used for directing the engaging user 304 through the appropriate subscription and/or billing sequence. Specifically, based on predefined associations or definitions stored within the storage device 104, the primary network device 102 may be able to extract and determine the appropriate landing page 314 to which the user 304 should be directed. In web-based implementations, for example, the storage device 104 may contain predefined associations between different outgoing reference codes 312 and different web pages or web site addresses leading to the appropriate landing pages 314.

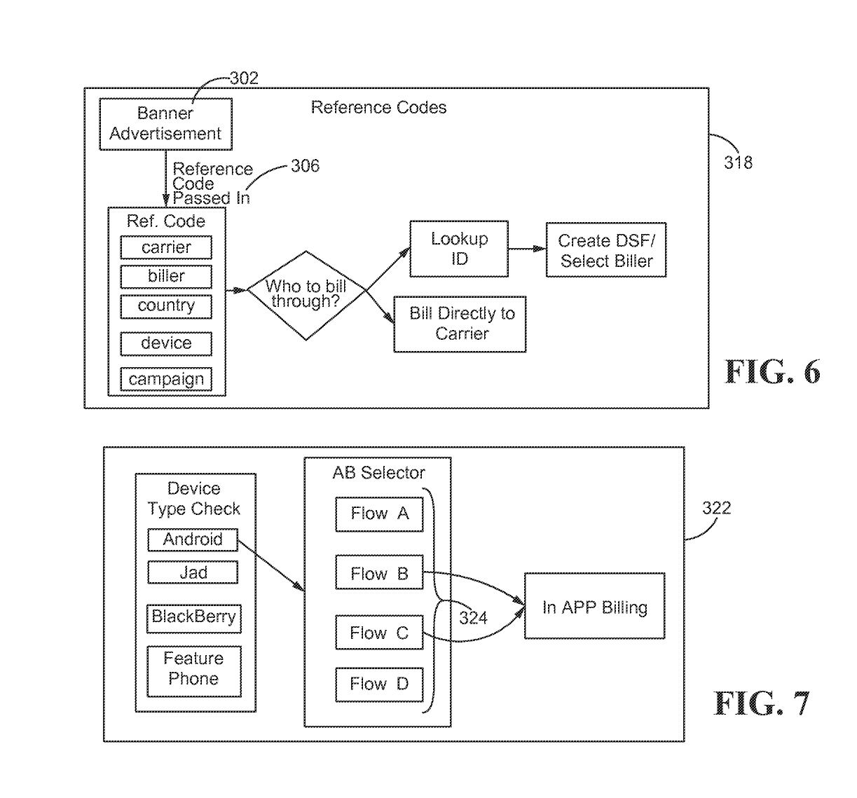

Once at the landing page 314, the user 304 may be directed to different pages within the web site including subscription and/or billing pages 316. Within a subscription page 316, the primary network device 102 may be configured to request and receive information from the user 304 necessary to successfully complete the user's subscription. Similarly, when the service or product requested by the user 304 requires payment, the user 304 may be directed to a billing page 316 where the primary network device 102 may be configured to request and receive information from the user 304 necessary to successfully complete the user's transaction. Within a billing page 316, the primary network device 102 may be configured to execute a billing process 318, as shown for example in FIG. 6. Specifically, the billing process 318 may again refer to the reference code 306 to determine, among other things, the method of payment by which to complete a transaction that may be initiated by the user 304. As shown, the billing process 318 may receive one or more of the user's carrier information, billing information, country of residence, client device type, as well as the referral or A/B randomized advertising campaign through which the user 304 arrived at the subscription or billing page 316. In other modifications, the billing page 316 may also request authorization of payment from the user 304 to be applied later if it is otherwise unable to confirm a means of completing the transaction.

Referring back to FIG. 4, the outgoing reference code 312 may be forwarded to the subscription or billing pages 316 such that any relevant user-specific information may be extracted for the purposes of personalizing and facilitating the subscription or billing experience for the user 304. For example, based on information contained within the reference code 312, a lookup process 320 may automatically search one or more databases 104 that are accessible to the primary network device 102 to determine if the user 304 already has an existing account affiliated with any of the primary network device 102 or third-party or secondary network devices 108, and to identify the user 304 for the purposes of completing the necessary transactions. If the user 304 is identifiable and/or an account already exists for the user 304, the primary network device 102 may apply that information to automatically complete, or at least partially fill, the user's subscription and/or transaction. Furthermore, if such existing account information is sufficient to complete the necessary transactions, the primary network device 102 may automatically complete and close such transactions for the engaging user 304, and optionally or additionally, proceed to a device check process 322, or the like.

If a transaction is successfully completed during the lookup process 320, the primary network device 102 may direct the user 304 to the desired end product or service while designating the process flow as a positive delivery or marking the process iteration with a positive delivery flag, as shown by dashed lines in FIG. 4. If user information is available but the transaction is unsuccessful, the primary network device 102 may be configured to prompt the user 304 of the failure and request the appropriate corrections needed to complete the transaction. In still further embodiments, if no account information of the user 304 is retrievable during the lookup process 320 to sufficiently complete the transaction, but user authorization for the transaction has been previously obtained or established, the transaction may be temporarily bypassed for the user's convenience. More specifically, if the user 304 is not identifiable by substantially automated means, the primary network device 102 may be configured to first determine whether the user 304 had previously established any authorization to bill the user 304, for example, at the billing page 316, or the like. If such authorization is detected, the primary network device 102 may temporarily forego fulfillment of the transaction and allow the process flow to proceed, however, with a negative delivery flag or designation, as also shown in FIG. 4.

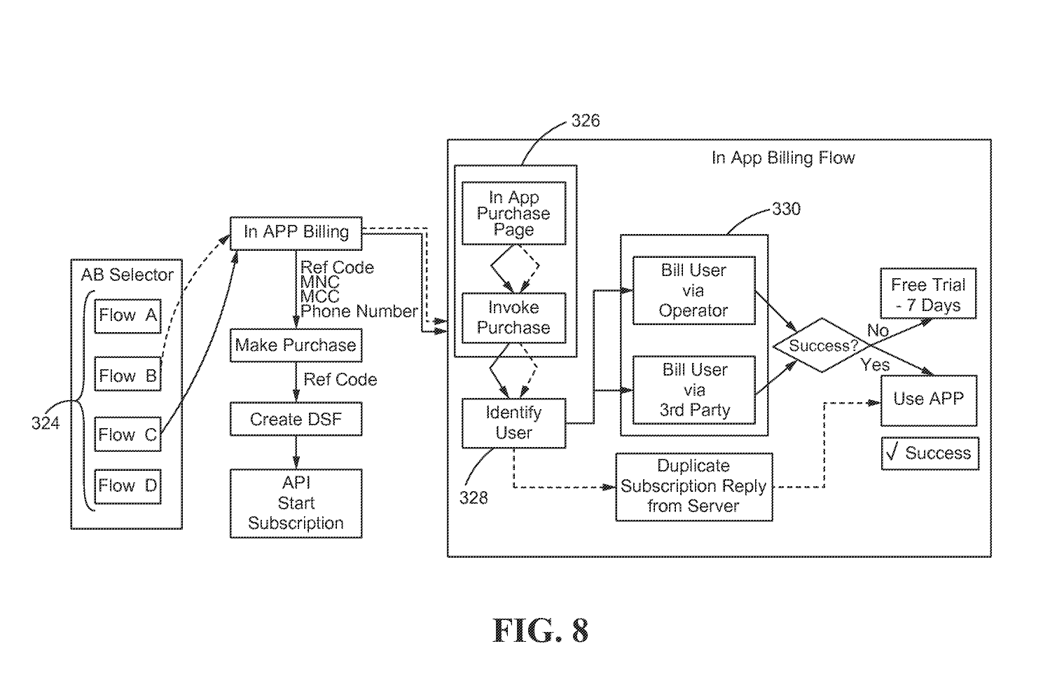

For those accounts or processes flagged as a negative delivery, the primary network device 102 may be configured to fulfill those transactions at a later time and with minimal involvement of the user 304, for example, via a silent in-app billing scheme as shown in FIGS. 7 and 8. In FIG. 7, for instance, the device check process 322 of the primary network device 102 may be configured to automatically determine the type of client device 112 that is being used by the user 304. More specifically, based on any relevant information extracted from the reference code 312 that may be available, the primary network device 102 may be able to distinguish, for example, whether the client device 112 is a mobile device, a smartphone, a laptop computer, a desktop computer, or the like, and further, may be able to determine the corresponding operating system of the client device 112. Furthermore, the storage device 104 associated with the primary network device 102 may include one or more executable billing sequences 324, each of which may be better suited for a different device type and/or operating system. Thus, the primary network device 102 may be able to automatically select the most appropriate billing sequence 324 according to the client device type and/or operating system detected during the device check process 322.

Turning now to FIG. 8, one exemplary billing sequence 324, by which the primary network device 102 may complete a transaction, is provided. As shown, one of the types of billing sequences 324 that may be selected during the device check process 322 may be an in-app type billing sequence, or a billing sequence which may be executed from within an application or program commonly used with smartphones, mobile devices, and other related computation devices. More specifically, as provided within the exemplary in-app type billing sequence of FIG. 8, the user 304 may be directed to an in-app purchase page 326. The primary network device 102 may additionally attempt to automatically identify the user 304, the user's device 112, and/or any other relevant user-specific information that may be obtained from the reference code 312 in an identification lookup process 328 to further facilitate and personalize the transaction.

During the identification lookup process 328, the primary network device 102 may search accessible databases or storage devices 104 to determine whether the user 304 already has an active subscription, service or other payment on file, for example, a previous transaction completed during the billing process 318 of FIG. 6. If the user 304 is identified and if such an active subscription or service is located, such as in the positive delivery process flow shown by dashed lines in FIG. 4, the primary network device 102 may grant the user 304 access to the subscription, service or product requested. Alternatively, if no active subscription, service or other payment is located for the user 304, such as in the negative delivery process flow shown by solid lines in FIG. 4, the primary network device 102 may proceed to silently bill the user 304 through an associated service provider, operator, third-party affiliate, or any other suitable billing scheme 330 to which the user 304 agrees.

If none of the billing schemes 330 of FIG. 8 result in a successful completion of the transaction, the primary network device 102 may at least temporarily limit user access to the desired subscription, end product or service. For example, upon a failed transaction, the primary network device 102 may allow the user 304 a free trial of the service or product for a predefined duration of time. However, if any one of the billing schemes 330 applied results in a successful completion of the transaction, the primary network device 102 may grant the user 304 full access to the subscription, end product or service requested. Furthermore, once such transactions are fulfilled, those advertising campaigns 310 that have been previously flagged as negative deliveries may be converted to positive deliveries, and further, designated as a successful conversion for analytics and other assessment purposes. In such a way, the primary network device 102 may be able to provide a more comprehensive and reliable assessment of conversions between advertising campaigns 310 while minimizing interruptions to the user's overall experience.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method for optimizing ad-based conversions, comprising the steps of:
receiving user input from a user through one or more ad-based entry points, each entry point providing one or more reference codes in response to the user input;
initiating a subscription sequence based on the reference codes;
randomizing a plurality of concurrently available advertising campaigns selected based on the reference codes;
selecting at least one landing page from the randomized advertising campaigns to be presented to the user based on the reference codes; and
determining a conversion rate based at least partially on one or more of the reference codes, the engaged entry point, the selected advertising campaign and landing page.

2. The method of claim 1, wherein the entry points are engageable through one or more of advertisement banners, web pages, instant messages, text messages, shortcodes and phone calls, using one or more of a mobile device, a cellular device, a computer, and a landline phone.

3. The method of claim 1, wherein the reference codes include user-specific information pertaining to one or more of the user's identity, location, device, cellular service provider, internet service provider, demographic information, and relevant advertising campaigns.

4. The method of claim 3, further comprising the step of extracting the user-specific information from the reference codes using an extraction process.

5. The method of claim 3, wherein the user-specific information is employed to personalize one or more of the advertising campaigns and the landing page to the user's preferences, and to facilitate the subscription sequence for the user.

6. The method of claim 1, wherein the conversion rate is calculated based on any successful subscription achieved during the subscription sequence.

7. The method of claim 1, further comprising the step of initiating a billing sequence based on the reference codes upon request by the user.

8. The method of claim 7, wherein the conversion rate is calculated based at least partially on any successful billing achieved during the billing sequence.

9. A method for optimizing ad-based conversions, comprising the steps of:
initiating a subscription sequence based on user input received from a user through one or more ad-based entry points, each entry point providing one or more reference codes in response to the user input;
extracting information specific to the user from the reference codes;
randomizing a plurality of concurrently available advertising campaigns selected based on the reference codes;
selecting at least one landing page from the randomized advertising campaigns to be presented to the user based on the reference codes; and
determining a conversion rate based at least partially on one or more of the reference codes, the engaged entry point, the selected advertising campaign and landing page.

10. The method of claim 9, wherein the entry points are engageable through one or more of advertisement banners, web pages, instant messages, text messages, shortcodes and phone calls, using one or more of a mobile device, a cellular device, a computer, and a landline phone.

11. The method of claim 9, wherein one or more of the user's identity, location, device, cellular service provider, internet service provider, demographic information, and relevant advertising campaigns are extracted from the reference codes.

12. The method of claim 9, wherein the reference codes include predefined associations between one or more of entry points, advertising campaigns, landing pages, and user-specific information.

13. The method of claim 9, further comprising the step of initiating a billing sequence based on the reference codes upon request by the user.

14. A system for optimizing ad-based conversions, comprising:
a storage device configured to retrievably store information pertaining to one or more of ad-based entry points, reference codes, advertising campaigns, landing pages, and any predefined associations therebetween; and
a primary network device in communication with the storage device, the primary network device having at least one processor configured to receive user input from a user through one or more entry points, each entry point providing one or more reference codes in response to the user input, initiate a subscription sequence based on the reference codes, randomize a plurality of concurrently available advertising campaigns selected based on the reference codes, select at least one landing page from the randomized advertising campaigns to be presented to the user based on the reference codes, and determine a conversion rate based at least partially on one or more of the reference codes, the engaged entry point, the selected advertising campaign and landing page.

15. The system of claim 14, wherein the entry points are engageable through one or more of advertisement banners, web pages, applications, programs, instant messages, text messages, shortcodes and phone calls, using one or more of a mobile device, a cellular device, a computer, and a landline phone.

16. The system of claim 14, wherein the reference codes include user-specific information pertaining to one or more of the user's identity, location, device, cellular service provider, internet service provider, demographic information, and relevant advertising campaigns.

17. The system of claim 16, wherein the processor is further configured to extract the user-specific information from the reference codes using an extraction process.

18. The system of claim 16, wherein the processor employs the user-specific information to personalize one or more of the advertising campaigns and the landing page to the user's preferences, and to facilitate the subscription sequence for the user.

19. The system of claim 14, wherein the processor is further configured to initiate a billing sequence based on the reference codes.

20. The system of claim 19, wherein the processor calculates the conversion rate based at least partially on any successful subscription or billing achieved.
